(19) United States
(12) Patent Application Publication
(10) Pub. No.: US 2004/0153651 A1
(43) Pub. Date: Aug. 5, 2004

(54) Image forming device

(75) Inventor: Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/760,403

(22) Filed: Jan. 21, 2004

(30) Foreign Application Priority Data
Jan. 22, 2003 (JP) 2003-13263

(51) Int. Cl. H04L 9/00

(52) U.S. Cl. 713/176

(57) ABSTRACT

A replenishing liquid is filled in a replenishing liquid cartridge which is installed in a cartridge installation section of an image forming device. A seal, at which predetermined information including a cartridge ID for identifying that cartridge is encrypted and is printed as a two-dimensional bar code, is affixed to the replenishing liquid cartridge. When a new replenishing liquid cartridge is to be installed in the image forming device, the two-dimensional bar code printed on the seal is read, and, after being decrypted, the cartridge ID is extracted therefrom. Cartridge IDs of all replenishing liquid cartridges which have been installed in the image forming device in the past are stored in a table. By judging whether or not the extracted cartridge ID is not registered in the table, it is judged whether or not the replenishing liquid cartridge to be newly installed is a legitimate product.

### CROSS-REFERENCE TO RELATED APPLICATION

This application claims priority under 35 USC 119 from Japanese Patent Application No. 2003-13263, the disclosure of which is incorporated by reference herein.

### BACKGROUND OF THE INVENTION

1. Field of the Invention

The present invention relates to an image forming device, and in particular, to an image forming device which immerses and processes a recording material, on which images have been recorded, in processing liquids.

2. Description of the Related Art

Image forming devices carrying out the following operations have conventionally been known: an image is exposed and recorded onto a photographic printing paper either by irradiating light onto an image recorded on a photographic film and irradiating the light which has passed through the photographic film onto a photographic printing paper, or by reading an image by a CCD sensor or the like and scanning laser light, which is modulated on the basis of the image data obtained by reading, onto a photographic printing paper. The photographic printing paper is successively immersed in processing liquids which are a color developing liquid, a bleaching-fixing liquid, a washing liquid, or the like, and thereafter is dried. Then, the photographic printing paper is cut into image frames such that photographic prints are formed.

Various replaceable products can be installed into such an image forming device. Examples of such replaceable products are a replenishing liquid cartridge in which is filled replenishing liquid for replenishing a processing liquid, a cartridge which accommodates a photographic printing paper roll in which an elongated photographic printing paper is wound in the form of a roll, and the like. Photographic processing is carried out by using these replaceable products which are installed in the device main body. However, in addition to legitimate products which are manufactured and provided by the manufacturer or the like who manufactured the image forming device, replaceable products which are not legitimate products and which are manufactured by other manufacturers are also available on the market as replaceable products for image forming devices. When a replaceable product which is not a legitimate product is installed in an image forming device, drawbacks may arise at the image forming device main body, such as the initial performances of the image forming device can no longer be exhibited. Moreover, there is the problem that it is difficult to discover the cause when such a drawback arises.

In order to overcome the aforementioned problems, Japanese Patent Application Laid-Open (JP-A) No. 2002-316461 (hereinafter called “Patent Document 1”) discloses the following technique: an EEPROM in which copyright data is stored is attached to a toner set which is a replaceable product for a printer device. The same copyright data is also stored in the storage device of the printer device. When the toner set is installed in the printer device, the copyright data is read out from the EEPROM of the toner set and is compared with the copyright data stored in the storage device. If the data do not match, the toner set is considered to be a so-called pirated product, and driving is prevented.

However, in the technique disclosed in Patent Document 1, the problem arises that it is easy to manufacture a replaceable product, which will be erroneously judged to be a legitimate product at the device main body, simply by writing the copyright data, which is read from a replaceable product which is a legitimate product, to a storage element and attaching that storage element to a replaceable product. In the technique disclosed in Patent Document 1, because the act of manufacturing replaceable products which are not legitimate products is copyright infringement, it is possible to stop the manufacturing of replaceable products which are not legitimate products. However, it is difficult to prevent beforehand problems from arising at a device main body due to use of a replaceable product which is not a legitimate product, and it is difficult to discover the cause when some type of problem does arise.

### SUMMARY OF THE INVENTION

The present invention was developed in view of the aforementioned, and an object thereof is to provide an image forming device which can detect that a replaceable product which is not a legitimate product has been installed therein.

In order to achieve the above object, a first aspect of the present invention is an image forming device in and from which a predetermined replaceable product can be freely installed and removed, and which carries out image forming (photographic) processing by using an installed replaceable product, the image forming device comprising: a reading section for, at a time of installing a predetermined replaceable product, reading identification information which is held on (borne by) the replaceable product and which is for identifying that replaceable product among other replaceable products; a storing section for storing identification information borne by replaceable products which were installed in the past; and a control section for judging whether or not the replaceable product is a legitimate product by judging whether or not the identification information read by the reading section is not stored in the storing section, and for storing the identification information in the storing section if the identification information is not stored in the storing section.

In the invention of the first aspect, identification information, which is for identifying an individual replaceable product, is borne by a replaceable product which can be freely installed in and removed from the image forming device. Note that, when, for example, the image forming device relating to the present invention is structured so as to process a recording material such as a photographic printing paper or the like by immersing the recording material in processing liquids, the replaceable product relating to the present invention may be a cartridge in which is filled a replenishing liquid to be replenished to the processing liquid stored in the image forming device, or may be a cartridge accommodating the recording material, or the like. Further, the identification information borne by the replaceable product may be recorded as a two-dimensional bar code on the replaceable product as in the second aspect of the present invention for example. Or, for example, as in the third aspect of the present invention, when a recording element, at least from which written information can be read, is attached to the replaceable product, the identification information may be written in advance to the recording element.

In the invention of the first aspect, at the time when a predetermined replaceable product is installed, the reading of the identification information borne by the replaceable product is carried out by the reading section. Note that, in a case in which the identification information is recorded on the replaceable product as a two-dimensional bar code for example, the reading section can be structured so as to include a bar code reader. The invention of the first aspect has a storing section for storing identification information borne by the replaceable products which have been installed in the past. The control section judges whether or not the installed replaceable product is a legitimate product, by judging whether or not the identification information read by the reading section is not stored in the storing section.

In this way, even if persons, who are attempting to manufacture replaceable products which are not legitimate products, read identification information from a used replaceable product which is a legitimate product after that replaceable product has been installed in an image forming device and used, and then make a replaceable product which is not a legitimate product bear the read identification information, by storing the identification information borne by that replaceable product in the storing section, it is possible to detect that a replaceable product which is not a legitimate product is installed, without the replaceable product being misjudged by the control section as a legitimate product.

Further, in a case in which the identification information read by the reading section is not stored in the storing section, the control section makes that identification information be stored in the storing section. Therefore, the identification information, which is borne by the replaceable product which is a legitimate product and which is installed this time, can be prevented from being reused in the manufacture of replaceable products which are not legitimate products.

In the invention of the first aspect, for example, it is preferable that, as in the fourth aspect of the invention, the identification information is borne in an encrypted state by the replaceable product, and the reading section reads the identification information by decrypting the information read from the replaceable product. Note that, in the fourth aspect, for example, a method using public keys and private keys or the like, or any of various known methods can be used for the encrypting and decrypting of the identification information.

As described above, due to the identification information being borne by the replaceable product in an encrypted state, even if the identification information is read from a used replaceable product which is a legitimate product and which was installed and used in the image forming device, the read identification information is encrypted. Therefore, it is possible to prevent, for example, persons, who are attempting to manufacture replaceable products which are not legitimate products, from analyzing the rules for conferring the identification information (the numbering system or the like) on the basis of the read identification information, and from preparing identification information which is not stored in the storing section of the image forming device. Accordingly, in accordance with the invention of the fourth aspect, manufacturing of replaceable products which are not legitimate products can be suppressed.

Further, in the first aspect of the invention, as in the fifth aspect for example, it is preferable that the image forming device is connected via a communication line to a managing device which stores identification information borne by replaceable products which have been installed in the past in plural image forming devices, and if the read identification information is not stored in the storing section, the control section judges whether or not the replaceable product is a legitimate product by confirming whether or not the read identification information is not stored in the managing device.

In this way, even if a replaceable product, which is not a legitimate product but which bears identification information read from a used replaceable product which is a legitimate product and which was installed and used in a given image forming device, is installed into another image forming device, by storing the identification information borne by that replaceable product in the managing device, it is possible to prevent that replaceable product from being mistakenly judged to be a legitimate product by the control section. Therefore, it is possible to reliably detect that a replaceable product which is not a legitimate product has been installed.

Further, in the first aspect of the invention, when the control section judges that the installed replaceable product is not a legitimate product, the control section may either issue a warning or carry out processing for preventing use of that replaceable product, as in the sixth aspect for example. In this case, it is possible to suppress or prevent use of replaceable products which are not legitimate products, and to prevent in advance problems or the like from arising at the image forming device due to use of a replaceable product which is not a legitimate product.

In the invention of the first aspect, when the control section judges that the installed replaceable product is not a legitimate product, the control section may confirm with a user whether or not the replaceable product is to be used, and if the user instructs use of the replaceable product, the control section may store, in the storing section, information expressing that the user instructed use of the replaceable product, as in the seventh aspect for example. In this case, although there is the possibility that problems or the like may arise at the image forming device by using a replaceable product which is not a legitimate product, the fact that the replaceable product which is not a legitimate product was used in accordance with the instruction of the user remains as a record. Therefore, if some type of problem arises, the cause thereof is easy to determine.

Moreover, in the invention of the first aspect, when the replaceable product relating to the present invention is a cartridge in which is filled replenishing liquid for replenishing a processing liquid stored in the image forming device, as in the eighth aspect, it is preferable that replenishing condition information, which expresses conditions for replenishing the replenishing liquid filled in the cartridge to the processing liquid, is also borne, and the control section controls replenishment of the replenishing liquid to the processing liquid on the basis of the replenishing condition information read from the cartridge by the reading section. In this way, the replenishing liquid filled in the cartridge is replenished to the processing liquid under replenishing conditions which are suited to that replenishing liquid, and the processing accuracy of the photographic processing carried out at the image forming device can be improved.

In particular, various improvements are continuously being made to recording materials, such as photographic printing papers and the like, in order to improve image quality, improve the long-term storability of the material, increase the speed of processing, and the like. Similarly, with processing liquids as well, improvements are being made in order to decrease the replenished amount, improve the degree of acid resistance, improve the degree of activity, and the like. Therefore, the number of combinations of recording materials and processing liquids (replenishing liquids) is reaching an extremely large number. A structure in which the replenishing conditions are determined for, for example, each type of recording material and are borne by the cartridge as replenishing condition information, and the control section controls the replenishing of the replenishing liquid to the processing liquid on the basis of the replenishing condition information corresponding to the type of the recording material installed in the image forming device among the replenishing condition information read from the cartridge, is preferable because the processing accuracy of the photographic processing carried out at the image forming device can be improved regardless of the combination of the recording material and the processing liquid (the replenishing liquid).

Further, in the invention of the first aspect, it is preferable that, as in the ninth aspect for example, voice information, which expresses a voice explaining in a predetermined language work procedures for one of installing and replacing the replaceable product, also is recorded at the replaceable product, and the image forming device further comprises a playback section for playing-back, as a voice, the voice information read by the reading section. Note that, an example of the predetermined language in the invention of the ninth aspect is a non-standard language which is not used in, for example, the manual or the like of the image forming device (specifically, a language other than, for example, English, French, German, or the like).

As a rule, devices which are exported to foreign countries are accompanied by a manual written in the language of the region of export. However, when a device is to be exported to a large number of countries, it is difficult to produce manuals which are written in the languages of all of the places of export. Therefore, it is often the case that the device is accompanied by a manual written only in standard languages. However, operations such as installation, replacement, and the like of replaceable products must be periodically carried out at the image forming device. In places of export which commonly use a non-standard language, when an operator carries out the work of installing or replacing or the like the replaceable product, he/she must grasp the procedures of operation by referring to a manual which is written in a standard language which he/she does not ordinarily use. Therefore, a great burden is placed on the operator.

Therefore, in the invention of the ninth aspect, when a predetermined replaceable product is to be installed, voice information borne by the replaceable product (voice information expressing a voice which explains in a predetermined language the work procedures for installing or replacing the replaceable product) is read by the reading section, and is played back as a voice by the playback section. Therefore, for example, if the voice information is prepared in various languages, and at the time of shipment of the replaceable product, the replaceable product to be shipped out is made to bear the voice information corresponding to the language commonly used in the place where the replaceable product is heading, or the like, the operator can ascertain the work procedures of the operations without a great burden being imposed on the operator who carries out the operations of installing or replacing the replaceable product.

A tenth aspect of the present invention is an image forming device in and from which a predetermined replaceable product can be freely installed and removed, and which carries out image forming processing by using an installed replaceable product, the image forming device comprising: a reading section for, at a time of installing a predetermined replaceable product, reading identification information which is held on the replaceable product and which is for identifying that replaceable product from other replaceable products; a storing section for storing identification information held on replaceable products which were installed in the past; and a control section for judging that the replaceable product is a legitimate product in a case in which the reading section cannot read the identification information, and for judging whether or not the replaceable product is a legitimate product by judging whether or not the identification information read by the reading section is not stored in the storing section, and for storing the identification information in the storing section if the identification information is not stored in the storing section.

An eleventh aspect of the present invention is an image forming device in and from which a predetermined replaceable product can be freely installed and removed, and which carries out image forming processing by using an installed replaceable product, the image forming device comprising: a reading section for, at a time of installing a predetermined replaceable product, reading identification information which is held on the replaceable product and which is for identifying that replaceable product from other replaceable products; a storing section for storing identification information held on replaceable products which were installed in the past; and a control section for judging whether or not the replaceable product is a legitimate product by judging whether or not the identification information, which indicates that a type of the replaceable product is the same as that of the predetermined replaceable product and identifies that replaceable product from other replaceable products, read by the reading section is not stored in the storing section, and for storing the identification information in the storing section if the identification information is not stored in the storing section.

### BRIEF DESCRIPTION OF THE DRAWINGS

FIG. 1 is a schematic structural view of an image forming device relating to an embodiment of the present invention.

FIG. 2 is a schematic structural view of a processor section of the image forming device.

FIG. 3 is a perspective view showing a replenishing liquid cartridge and an installation section.

FIG. 4 is a cross-sectional view showing the structure of a replenishing liquid cartridge cap opening section.

FIG. 5 is a block diagram showing the schematic structure of the electrical system of the image forming device.

FIG. 6 is a flowchart showing the contents of processing at the time of installing a cartridge.

FIG. 7 is a flowchart showing the contents of replenishing liquid replenishing processing.

FIG. 8 is a block diagram showing another example of the schematic structure of the electrical system of the image forming device.

### DETAILED DESCRIPTION OF THE INVENTION

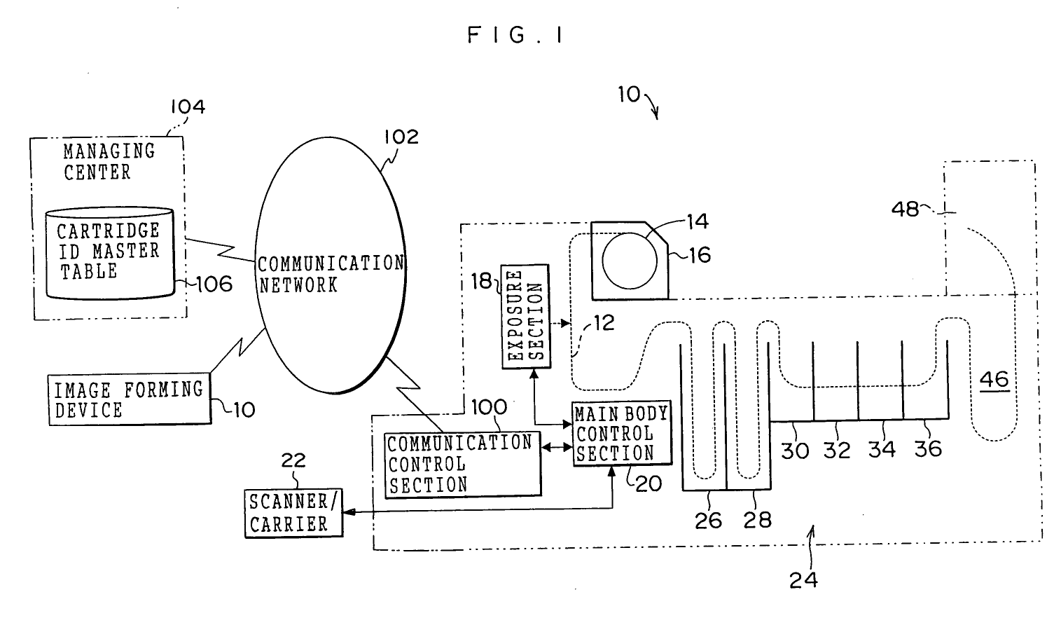

An embodiment of the present invention will be described in detail hereinafter with reference to the drawings. An image forming device 10 relating to the present embodiment is illustrated in FIG. 1.

The image forming device 10 corresponds to the image forming device relating to the present invention, and is set in a DPE shop or the like. The image forming device 10 is a device which exposes and records images onto a photographic printing paper, subjects the photographic printing paper to processings such as developing and the like, and forms photographic prints. A magazine 16, which houses a photographic printing paper roll 14 formed by winding an elongated photographic printing paper 12 the form of a roll on a core, can be installed into the image forming device 10. An exposure section 18 is provided in the image forming device 10. The exposure section 18 pulls the elongated photographic printing paper 12 out from the photographic printing paper roll 14 housed in the magazine 16, and scan-exposes a laser beam, which has been modulated in accordance with the images to be recorded on the photographic printing paper 12, onto the photographic printing paper 12 which has been pulled-out from the photographic printing paper roll 14, so as to expose and record images on the photographic printing paper 12.

The image forming device 10 has a main body control section 20 which controls the operations of the respective sections of the image forming device 10. A scanner/carrier 22, which reads an image recorded on an original such as a photographic film or the like conveyed by a carrier and which outputs the results of reading as image data, can be connected to the main body control section 20. In a case in which the scanner/carrier 22 is connected to the main body control section 20, the image data used in modulating the laser beam at the exposure section 18 is supplied from the scanner/carrier 22 via the main body control section 20. Note that the image data used for modulation may be image data which has been obtained by photographing a subject by a digital still camera (DSC).

A processor section 24 is provided at the image forming device 10. A color developing tank 26 in which a color developing liquid is stored, a bleaching/fixing tank 28 in which bleaching/fixing liquid is stored, and a first washing tank 30, a second washing tank 32, a third washing tank 34 and a fourth washing tank 36 in which wash water is stored, are provided in that order along the horizontal direction in the processor section 24. Conveying rollers 38, which convey the photographic printing paper 12 in a state in which the photographic printing paper 12 is submerged in the processing liquids, are provided in the color developing tank 26 and the bleaching/fixing tank 28. After being conveyed in the color developing liquid, the photographic printing paper 12 is fed by conveying rollers 40 from the color developing tank 26 to the bleaching/fixing tank 28, and is conveyed in the bleaching/fixing liquid in the bleaching/fixing tank 28.

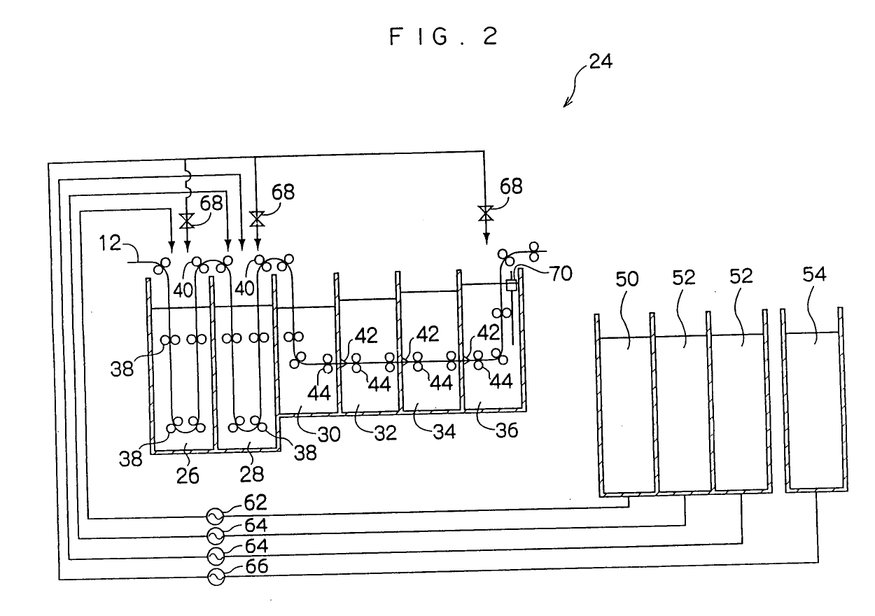

Further, as shown in FIG. 2, slits, through which the photographic printing paper 12 passes, are formed in the partitioning walls between the washing tanks 30, 32, 34, 36. A pair of blades 42, which are formed by elastic bodies, are provided in a vicinity of each slit so as to abut one another. The photographic printing paper 12 can pass through between each pair of blades 42. Conveying rollers 44, which convey the photographic printing paper 12 in the horizontal direction, are provided in the washing tanks 30, 32, 34, 36. Due to the photographic printing paper 12 passing through between the pairs of blades 42, the photographic printing paper 12 is conveyed from the first washing tank 30 to the fourth washing tank 36 while being conveyed in the wash water.

As shown in FIG. 1, a drying section 46 is provided at the downstream side of the fourth washing tank 36. The photographic printing paper 12, for which the washing processing in the fourth washing tank 36 has been completed, is fed from the fourth washing tank 36 to the drying section 46 where hot air generated by an unillustrated fan and heater is supplied such that the surfaces of the photographic printing paper 12 are dried. Moreover, a cutter/sorter 48 is disposed at the downstream side of the drying section 46. The photographic printing paper 12, whose surfaces have been dried in the drying section 46, is cut into image frames by the cutter/sorter 48, and thereafter, the cut photographic printing papers 12 are sorted per order.

Next, replenishing of the replenishing liquids into the respective processing tanks of the processor section 24 will be described. A developing replenishing tank 50 in which color developing replenishing liquid is stored, bleaching/fixing replenishing tanks 52 in which bleaching/fixing replenishing liquids are stored, and a water tank 54 in which water is stored are provided in the processor section 24. Note that there are two types of bleaching/fixing replenishing liquids, and two of the bleaching/fixing replenishing tanks 52 are provided so as to correspond to the two types of bleaching/fixing replenishing liquids.

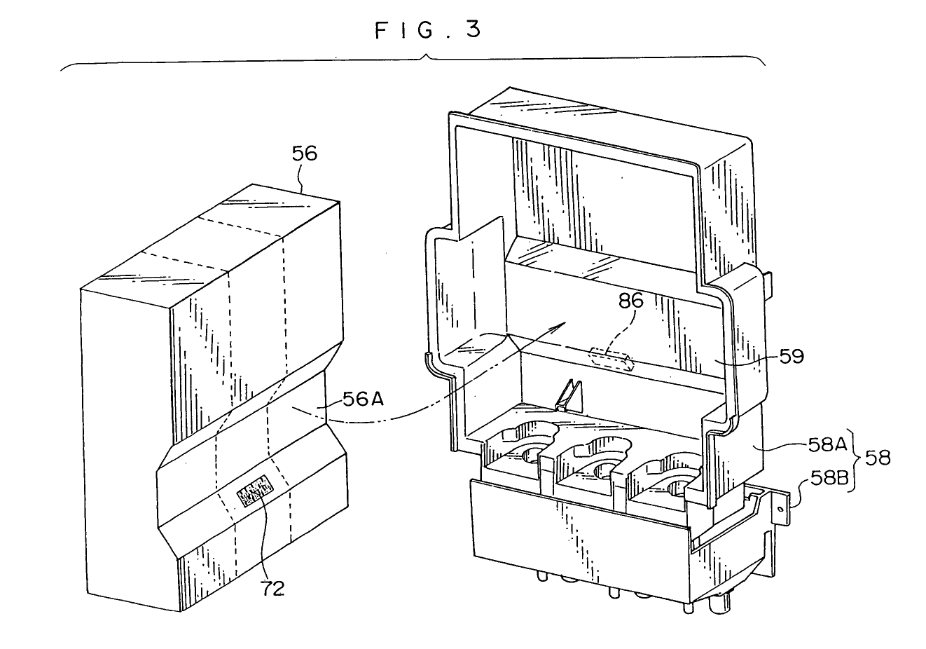

The color developing replenishing liquid and the bleaching/fixing replenishing liquids are supplied in a state of being filled in a replenishing liquid cartridge 56 shown in FIG. 3. The replenishing liquid cartridge 56 is formed, on the whole, in a substantially parallelepiped shape. A concave portion 56A is formed in the top-bottom direction intermediate portion thereof, from one transverse direction end thereof to the other transverse direction end. The interior of the replenishing liquid cartridge 56 is divided into three liquid compartments as shown by the dashed lines in FIG. 3. The color developing replenishing liquid and the (two types of) bleaching/fixing replenishing liquids are filled in respectively different liquid compartments. Note that the replenishing liquid cartridge 56 corresponds to the replaceable product relating to the present invention (and specifically to the cartridge of the eighth aspect).

A cartridge installation section 58 for installing of the replenishing liquid cartridge 56 is provided at the processor section 24. By opening a door (not illustrated) at the side surface of the device body of the image forming device 10, the cartridge installation section 58 is exposed and the replenishing liquid cartridge 56 can be installed therein. Note that an interlocking mechanism (not illustrated) for preventing the door from being opened at times other than when the replenishing liquid cartridge 56 is being replaced, is provided at the door.

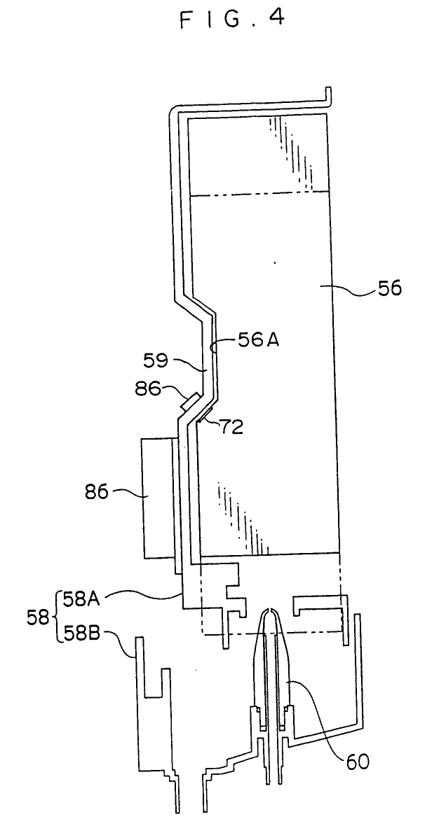

Although not illustrated, replenishing liquid discharge openings are provided at the bottom of the replenishing liquid cartridge 56 in correspondence with the respective liquid compartments. The replenishing liquid discharge openings are closed by caps. The replenishing liquid cartridge 56 is installed into the cartridge installation section 58 in a state in which the bottom thereof is directed downward. As shown in FIG. 4, the cartridge installation section 58 is structured so as to include a cartridge receiving portion 58A for supporting the installed replenishing liquid cartridge 56, and a liquid receiving portion 58B for guiding the replenishing liquids, which are discharged out from the replenishing liquid cartridge 56, to the corresponding replenishing tanks.

A convex portion 59, which corresponds to the concave portion 56A of the replenishing liquid cartridge 56, is formed at the cartridge receiving portion 58A. Due to the convex portion 59 fitting together with the concave portion 56A of the replenishing liquid cartridge 56 in a state in which the replenishing liquid cartridge 56 is installed, the replenishing liquid cartridge 56 is held at a fixed position. Further, the cartridge receiving portion 58A is raised and lowered by an unillustrated raising/lowering driving section.

Cap opening nozzles 60, which are for opening the caps which close the replenishing liquid discharge openings of the replenishing liquid cartridge 56, stand erect at the liquid receiving portion 58B. When the cartridge receiving portion 58A is lowered to its lowermost position, in the state in which the cartridge receiving portion 58A supports the installed replenishing liquid cartridge 56, the caps of the replenishing liquid discharge openings of the replenishing liquid cartridge 56 supported at the cartridge receiving portion 58A are opened by the cap opening nozzles 60. As the caps are opened, the replenishing liquids in the respective liquid compartments are discharged out via the replenishing liquid discharge openings The discharged replenishing liquids are guided and supplied to the corresponding replenishing tanks via the liquid receiving portion 58B.

The color developing replenishing liquid in the developing replenishing tank 50 is replenished to the color developing tank 26 by a pump 62. The bleaching/fixing liquids in the bleaching/fixing replenishing tanks 52 are replenished to the bleaching/fixing tank 28 by pumps 64. The water in the water tank 54 is replenished to the color developing tank 26, the bleaching/fixing tank 28, and the fourth washing tank 36 by a pump 66. Note that solenoid valves 68 are provided along the pipes leading from the pump 66 to the color developing tank 26, the bleaching/fixing tank 28, and the fourth washing tank 36.

In the present embodiment, the replenishing of water to the wash tanks is carried out with respect to the fourth wash tank 36 which is the furthest downstream. When wash water is replenished to the fourth wash tank 36, the replenished wash water overflows successively into the upstream side wash tanks, and ultimately is discharged to a discharge liquid tank (not illustrated) from the first wash tank 30. Accordingly, the first through the fourth wash tanks are a so-called cascade form in which, the further downstream the wash tank, the higher the degree of cleanliness of the wash water. Further, a liquid concentration detecting sensor 70 is provided at the fourth wash tank 36. The liquid concentration detecting sensor 70 has a pair of electrodes which are disposed so as to be separated from one another, and is used in a state in which the pair of electrodes are submerged in the processing liquid (the wash water). The output voltage of the liquid concentration detecting sensor 70 changes in accordance with the concentration of liquid components of the wash water (e.g., the concentration of the iron components included in the bleaching/fixing liquid).

As shown in FIG. 3, the concave portion 56A, which is formed in the replenishing liquid cartridge 56 relating to the present embodiment, is formed such that the cross-section thereof is substantially mountain-shaped due to the side surfaces of the concave portion 56A being inclined with respect to the bottom surface (and the top surface) and the side surface of the replenishing liquid cartridge 56. A seal 72, on which a two-dimensional bar code is printed, is affixed to a side surface of the convex portion 56A. The two-dimensional bar code printed on the seal 72 may be a stacked-type or a matrix-type bar code.

A bar code reader 86 is provided at the cartridge installation section 58 at a position (i.e., at a side surface of the convex portion 59 of the cartridge receiving portion 58A) which faces (the two-dimensional bar code printed on) the seal 72 in the state in which the replenishing liquid cartridge 56 is installed in the cartridge installation section 58 (refer to FIGS. 3 and 4). The bar code reader 86 has a light emitting element which emits light for irradiating the two-dimensional bar code printing on the seal 72, and a photoelectric converting element such as an area CCD or the like which receives the light which has been emitted from the light emitting element and reflected by the two-dimensional bar code. The bar code reader 86 functions to read the two-dimensional bar code printed on the seal 72.

Note that the replenishing liquid cartridge 56 installed in the cartridge installation section 58 is held at a fixed position by the concave portion 56A being fit together with the convex portion 59. Therefore, by affixing the seal 72 to a side surface of the concave portion 56A of the replenishing liquid cartridge 56 and setting the bar code reader 86 at a side surface of the convex portion 59 of the cartridge receiving portion 58A as described above, when the replenishing liquid cartridge 56 is installed in the cartridge installation section 58, the seal 72 and the bar code reader 86 are set apart at an extremely small and uniform interval, and at a positional relationship which is such that the bar code reader 86 can reliably read the two-dimensional bar code printed on the seal 72.

The bar code reader 86 is connected to a replaceable product managing section 94. The replaceable product managing section 94 is connected to the main body control section 20 and to a memory section 98 formed by a storage device such as a hard disk drive (HDD) or the like. A cartridge ID table (details of which will be described later) is stored in the memory section 98. The cartridge ID table is updated by the replaceable product managing section 94. Moreover, the memory section 98 is also connected to the main body control section 20. A display 110, which is formed by an LCD or the like, and an input section 112, which is formed so as to include a plurality of keys, are connected to the main body control section 20. Moreover, a speaker 116 is connected to the main body control section 20 via an amplifier 114.

Further, as shown in FIG. 1, the main body control section 20 is connected to a communication network 102 via a communication control section 100. The communication network 102 may be the internet or the like, or may be a network formed by a dedicated line. A managing center 104, at which a computer (not illustrated) and a large-capacity storage device 106 are set, is connected to the communication network 102. A cartridge ID master table (details of which will be described later) is stored in the storage device 106 of the managing center 104. Further, other image forming devices 10 which are working are also connected to the communication network 102. The main body control sections 20 of the respective image forming devices 10 can communicate with (the computer of) the managing center 104 via their respective communication control sections 100 and the communication network 102.

Next, as operation of the present embodiment, first, the two-dimensional bar code which is printed on the seal 72 affixed to the replenishing liquid cartridge 56 will be described. At the manufacturer which manufactures the replenishing liquid cartridge 56, color developing replenishing liquid and (two types of) bleaching/fixing replenishing liquids are filled into the three liquid compartments which are empty bottles of the replenishing liquid cartridge 56, so as to manufacture the replenishing liquid cartridge 56. Further, predetermined information, which is to be borne as a two-dimensional bar code by each manufactured replenishing liquid cartridge 56, is prepared.

This predetermined information includes ID (e.g., a manufacture number) for identifying that replenishing liquid cartridge 56. The name of the manufacturer of the replenishing liquid cartridge 56, the manufacturer code, the product type, the expiration date of the filled replenishing liquids, the names of the formulas for processing by the processing liquids replenished by the filled replenishing liquids, attribute information expressing the attributes of the replenishing liquid cartridge 56 such as the weight or the like of the replenishing liquids or the overall replenishing liquid cartridge 56, replenishing condition information stipulating the appropriate conditions for replenishing the replenishing liquids filled in the replenishing liquid cartridge 56 to the processing liquids, and the like are added to this ID. Note that information providing the replenishing conditions for, for example, each type of photographic printing paper currently available on the market can be used as the replenishing condition information.

Moreover, in a case in which the manufactured replenishing liquid cartridge 56 is intended for export to a country or a geographical region commonly using a specific, non-standard language (e.g., a language which is not written in the manual for the image forming device 10), voice information, which expresses a voice which explains the work procedures for installing or replacing the replenishing liquid cartridge 56 into the image forming device 10 in that specific, non-standard language, is also added to the predetermined information. Note that, in order to keep the information amount of the predetermined information from becoming large, it is preferable that the voice information be compressed (the sound quality thereof lowered) within a range in which an operator who is listening to the voice being played-back can still grasp the work procedures.

When predetermined information such as that described above is prepared, the manufacturer encrypts the prepared, predetermined information by a private key, prints the encrypted, predetermined information onto the seal 72 as a two-dimensional bar code, and affixes the seal 72 on which the two-dimensional bar code is printed onto a predetermined position of the corresponding replenishing liquid cartridge 56. Currently, two-dimensional bar codes can bear information of an information amount of about 2000 characters when converted into text data. If the information is about as much as that described above, the two-dimensional bar code printed on the seal 72 can sufficiently bear the information. Note that the public key for decrypting the information expressed by the two-dimensional bar code printed on the seal 72 is distributed in advance to each of the image forming devices 10, and is stored in the memory sections 98 of the respective image forming devices 10.

The replenishing liquid cartridge 56, to which is affixed the seal 72 on which the two-dimensional bar code is printed, is shipped out from the manufacturer and delivered to a user who has the image forming device 10, and is stored by the user until installation thereof into the image forming device 10 is required. When it becomes necessary for replenishing liquids to be replenished to the replenishing tanks at the image forming device 10 which the user has, the user takes the new replenishing liquid cartridge 56 which they have been storing, and informs the image forming device 10 that they will be replacing the replenishing liquid cartridge 56. The locking of the door at the side surface of the device body is thereby released. The user opens the door at the side surface of the device body, removes the empty replenishing liquid cartridge which is installed in the cartridge installation section 58, installs the new replenishing liquid cartridge 56 into the cartridge installation section 58, and closes the door.

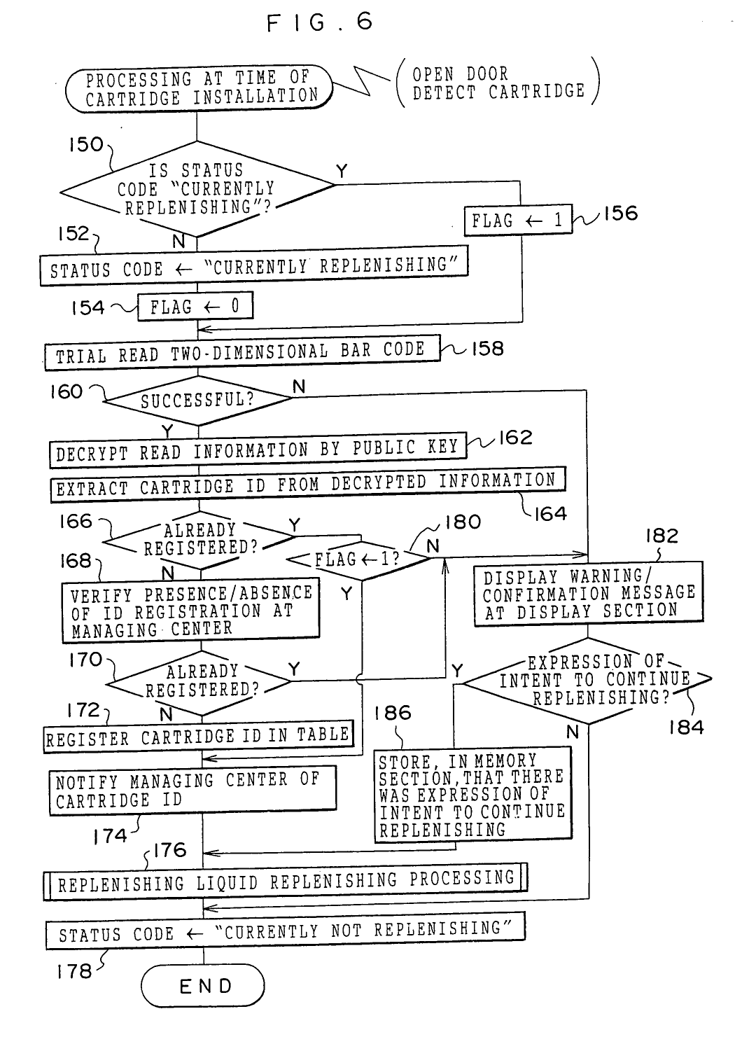

When the aforementioned operations are carried out, processing at the time of cartridge installation is carried out at the main body control section 20. This processing at the time of cartridge installation will be described hereinafter with reference to the flowchart of FIG. 6.

A status code storage area, which is for storing the status code expressing the status of the image forming device 10, is provided in the memory section 98 of the image forming device 10 relating to the present embodiment. In step 150, by referring to the status code storage area, it is judged whether or not the status code expressing “currently replenishing” is set in that area. This status code is set to “currently replenishing” only during times when the replenishing liquids are being replenished from the replenishing liquid cartridge 56 into the replenishing tanks. Therefore, usually, the determination is negative, and the routine moves on to step 152. In step 152, the status code expressing “currently replenishing” is set in the status code storage area. In next step 154, “0” is substituted in for a flag. On the other hand, if the determination in step 150 is affirmative, “1” is substituted in for the flag.

In step 158, trial reading of the two-dimensional bar code printed on the seal 72 affixed to the replenishing liquid cartridge 56 installed in the cartridge installation section 58 is carried out by the bar code reader 86. In step 160, it is judged whether or not reading of the two-dimensional bar code by the processing of step 158 was successful. If the seal 72 on which the two-dimensional bar code is printed is affixed to a predetermined position of the replenishing liquid cartridge 56 installed in the cartridge installation section 58, the judgment of step 160 is affirmative. The routine moves on to step 162 where the public key stored in advance in the memory section 98 is read, and the information, which was read by the bar code reader 86 and inputted via the replaceable product managing section 94 (i.e., the encrypted, predetermined information expressed by the two-dimensional bar code) is decrypted by using the read public key.

Note that the processings of above steps 158, 162, together with the bar code reader 86 which actually carries out reading of the two-dimensional bar code, correspond to the reading section of the present invention (specifically, the reading section of the fourth aspect).

In step 164, the cartridge ID of the replenishing liquid cartridge 56 installed in the cartridge installation section 58 is extracted from the predetermined information which was decrypted in step 162. The processings from subsequent step 166 on correspond to the control section of the present invention. First, in step 166, by searching the cartridge ID table stored in the memory section 98 by using the cartridge ID extracted in step 164 as a key, it is judged whether or not the cartridge ID of the replenishing liquid cartridge 56 installed in the cartridge installation section 58 is already registered in the cartridge ID table.

The cartridge ID table is a table in which are registered the cartridge IDs of all of the replenishing liquid cartridges 56 which have been installed in the image forming device 10 in the past. The memory section 98 in which the cartridge ID table is stored corresponds to the storing section relating to the present invention. If the replenishing liquid cartridge 56 installed in the cartridge installation section 58 is a legitimate product, the cartridge ID extracted in step 164 is not registered in the cartridge ID table. Therefore, the determination in step 166 is negative, and the routine proceeds to step 168.

In step 168, by transmitting the cartridge ID extracted in step 164 to (the computer of) the managing center 104 via the communication control section 100 and the communication network 102, it is verified whether or not the cartridge ID read from the replenishing liquid cartridge 56 is registered in the cartridge ID master table stored in the storage device 106. Then, in subsequent step 170, on the basis of information received from the managing center 104, it is judged whether or not the cartridge ID is already registered in the cartridge ID master table. Note that steps 168, 170 specifically correspond to the control section of the fifth aspect.

At the managing center 104, when the presence/absence of registration of the cartridge ID is verified from a specific image forming device 10, by searching the cartridge ID master table by using the received cartridge ID as a key, it is searched whether or not the received cartridge ID is registered. The results of the search (the absence/presence of registration) is notified to the image forming device 10 which is the source of verification (from which that cartridge ID was transmitted). The cartridge ID master table is a table in which are registered the cartridge IDs of all of the replenishing liquid cartridges 56 which have been installed in the past into all of the image forming devices 10 connected to the communication network 102. If the replenishing liquid cartridge 56 installed in the cartridge installation section 58 is a legitimate product, the cartridge ID extracted in step 164 is not registered in the cartridge ID master table. Therefore, the determination in step 170 is negative, and the routine moves on to step 172.

In a case in which the determination in step 170 also is negative, it can be judged that the replenishing liquid cartridge 56 installed in the cartridge installation section 58 is a legitimate product. Therefore, in step 172, the cartridge ID read from the replenishing liquid cartridge 56 is registered in the cartridge ID table. Further, in subsequent step 174, the cartridge ID read from the replenishing liquid cartridge 56 is again transmitted to the managing center 104, and registration of the cartridge ID in the cartridge ID master table is requested. In this way, the cartridge ID received at the managing center 104 is registered in the cartridge ID master table.

Note that, at the managing center 104, when the presence/absence of registration of the cartridge ID is confirmed on the basis of the verification from the image forming device 10, in a case in which the verified cartridge ID is not registered in the cartridge ID master table, the verified cartridge ID may be registered in the cartridge ID master table. In this case, the image forming device 10, which ascertained that the cartridge ID was not registered in the cartridge ID master table, does not need to again request the managing center 104 to register the cartridge ID.

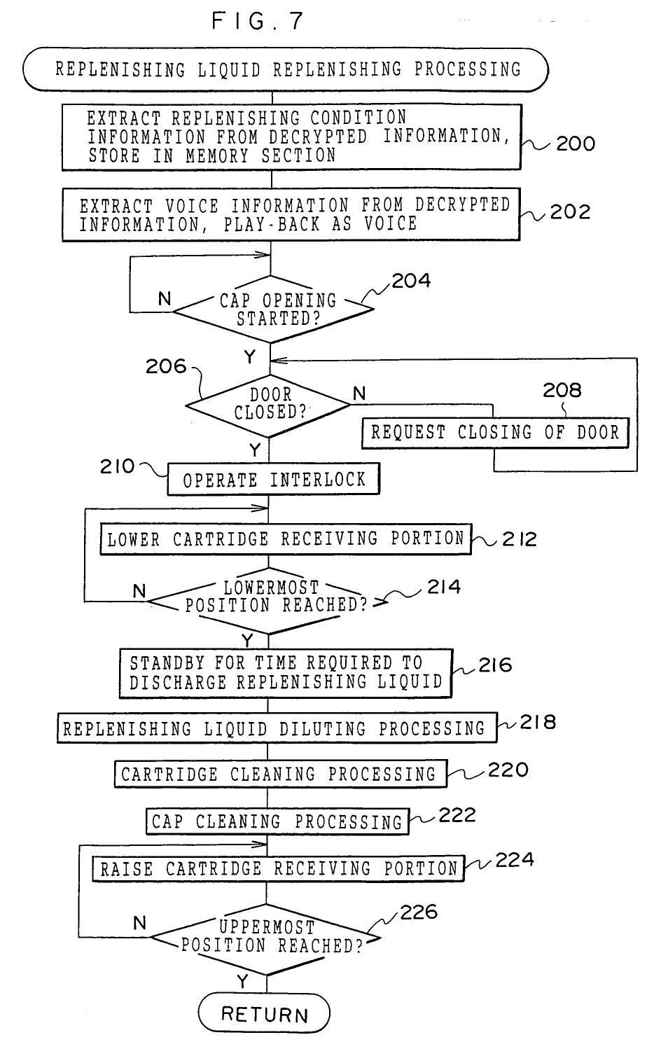

Replenishing liquid replenishing processing is carried out in next step 176. Hereinafter, the replenishing liquid replenishing processing will be described with reference to the flowchart in FIG. 7. In step 200, replenishing condition information is extracted from the predetermined information which was decrypted in previous step 162, and is stored in the memory section 98.

This replenishing condition information is information expressing the appropriate conditions for replenishing, to the processing liquids, the replenishing liquids filled in the replenishing liquid cartridge 56. The main body control section 20 controls the replenishing conditions, such as the frequency of replenishing, the replenished amount and the like of the replenishing liquid into each processing tank, by referring to the replenishing condition information stored in the memory section 98. In this way, replenishing of the replenishing liquids filled in the replenishing liquid cartridge 56 is carried out under replenishing conditions which are appropriate for those replenishing liquids. The state of the processing liquid in each processing tank can be maintained at an optimal state, and the processing accuracy of the photographic processing carried out at the image forming device (the image quality of the images which are made visible on the photographic printing paper 12 due to the photographic printing paper 12 being immersed in the respective processing solutions) can be improved. The above-described step 200, together with the processing for actually controlling the replenishing conditions, specifically correspond to the control section of the eighth aspect.

The replenishing condition information may be information stipulating the replenishing conditions for each type of photographic printing paper 12. If the replenishing conditions of the replenishing liquid are controlled in accordance with replenishing condition information corresponding to the type of the photographic printing paper 12 which is being subjected to photographic processing, the processing accuracy of the photographic processing can be further improved. In this case, all of the replenishing condition information corresponding to each type of the photographic printing paper 12 may be stored in the memory section 98. However, it is possible to store in the memory section 98 and to use only the replenishing condition information corresponding to the type of photographic printing paper 12 which is currently set at the image forming device 10.

Further, in step 200, the information expressing the name of the formula also is extracted from the predetermined information, and is stored in the memory section 98. The main body control section 20 also controls the temperatures of the processing liquids in the respective processing tanks and the times over which the photographic printing paper 12 is immersed in the processing liquids in the respective processing tanks (i.e., the speed of conveying the photographic printing paper 12), by referring to the information which expresses the formula name and which is stored in the memory section 98.

As described above, the seal 72, on which is printed the two-dimensional bar code expressing the predetermined information (but encrypted information) to which is added voice information which expresses a voice which explains the work procedures for installing or replacing the replenishing liquid cartridge 56 into the image forming device 10 in a specific, non-standard language, is affixed to the replenishing liquid cartridge 56 which is to be exported to a country or a geographical region ordinarily using the specific, non-standard language. In subsequent step 202, in a case in which the aforementioned voice information is included in the decrypted predetermined information, the voice information is extracted from the predetermined information, and the extracted voice information is converted into an analog voice signal and outputted to the amplifier 114.

In this way, the analog voice signal which has been amplified by the amplifier 114 is supplied to the speaker 116. A voice explaining, in the specific, non-standard language, the work procedures for installing or replacing the replenishing liquid cartridge 56 in the image forming device 10, is played-back from the speaker 116. Therefore, the operator can reliably be made aware of the work procedures, without a manual or the like written in the non-standard language being prepared. Note that step 202 corresponds to the playback section of the ninth aspect.

From next step 204 on, the replenishing liquids filled in the replenishing liquid cartridge 56 are replenished to the respective replenishing tanks. Namely, in step 204, it is judged whether the time for starting opening of the caps of the replenishing liquid cartridge 56 has been reached. If the judgment is negative, the judgment of step 204 is repeated until the judgment is affirmative. When the judgment of step 204 is affirmative, the routine moves on to step 206 where it is judged whether or not the door at the side surface of the device body of the image forming device 10 is closed. If the judgment is negative, the routine moves on to step 208 where the user is requested to close the door by a message requesting that the user shut the opened door being displayed on the display 110 or the like. The routine then returns to step 206.

When it is judged that the door is closed, the judgment of step 206 is affirmative, and the routine moves on to step 210 where, by operating the interlock mechanism which is provided so as to correspond to the door, inadvertent opening of the door is prevented. In subsequent step 212, the cartridge receiving portion 58A is lowered by the unillustrated raising/lowering driving section. Further, in step 214, it is judged whether or not the cartridge receiving portion 58A has reached the lowermost position. If the determination is negative, the routine returns to step 212, and steps 212 and 214 are repeated until the judgment of step 214 is affirmative. In this way, the lowering of the cartridge receiving portion 58A is continued until the cartridge receiving portion 58A reaches its lowermost position.

When an unillustrated lowermost position detecting sensor detects that the cartridge receiving portion 58A has reached its lowermost position, the judgment of step 214 is affirmative, and the routine moves on to step 216. Accompanying the arrival of the cartridge receiving portion 58A at its lowermost position, the caps of the replenishing liquid discharge openings of the replenishing liquid cartridge 56 are opened by the cap opening nozzles 60. Accompanying this opening of the caps, the replenishing liquids in the respective liquid compartments are discharged out through the replenishing liquid discharge openings, and the discharged replenishing liquids are guided and supplied to their corresponding replenishing tanks via the liquid receiving portion 58B. Step 216 is a state of standing by for the predetermined period of time (e.g., about several tens of seconds) required for the entire amounts of the replenishing liquids filled in the replenishing liquid cartridge 56 to be discharged out from the replenishing liquid cartridge 56 and supplied to the replenishing tanks.

In a state in which the frequency of installing (replacing) the replenishing liquid cartridge 56 is reduced and the image forming device 10 is operating regularly, concentrated replenishing liquids are filled in the replenishing liquid cartridge 56 relating to the present embodiment, such that it suffices to install (replace) the replenishing liquid cartridge 56 about once a week. In the next step 218, diluting processing for diluting the concentrated replenishing liquids such that the replenishing liquids replenished to the replenishing tanks become predetermined concentrations is carried out. The replenishing liquids, which have been made to be predetermined concentrations by this diluting processing, are appropriately replenished to the processing liquids in the respective processing tanks in accordance with the processed surface area or the like of the photographic printing paper 12 at the image forming device 10. Further, the cap opening nozzles 60 are provided with the function of cleaning the interiors of the liquid compartments of the replenishing liquid cartridge 56 and the caps. In step 220, the interiors of the liquid compartments of the replenishing liquid cartridge 56 are cleaned by the cap opening nozzles 60. In subsequent step 222, the caps which were opened by the cap opening nozzles 60 are cleaned by the cap opening nozzles 60.

When the cleaning processings of steps 220, 222 are completed, in subsequent step 224, the cartridge receiving portion 58A is raised by the unillustrated raising/lowering driving section. Further, in step 226, it is judged whether or not the cartridge receiving portion 58A has reached its uppermost position. If the judgment is negative, the routine returns to step 224, and steps 224, 226 are repeated until the judgment of step 226 is affirmative. In this way, the raising of the cartridge receiving portion 58A continues until the cartridge receiving portion 58A reaches its uppermost position.

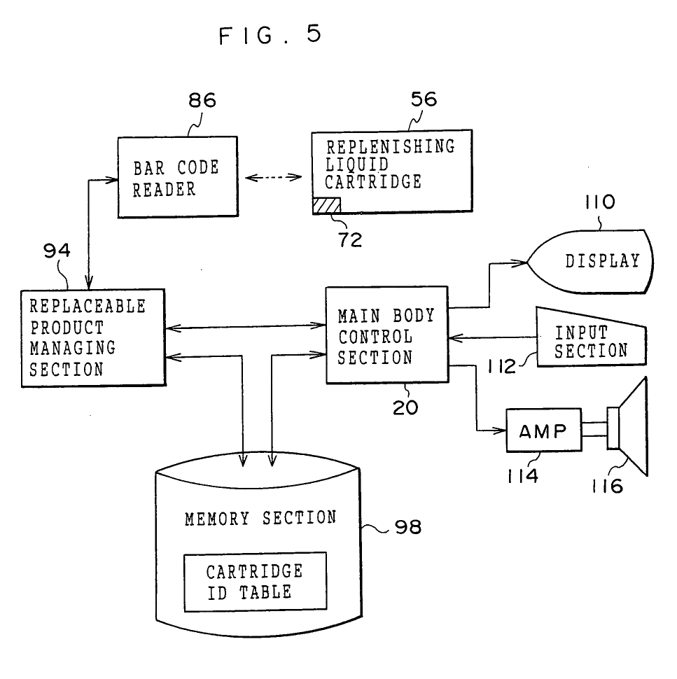

When an unillustrated uppermost position detecting sensor detects that the cartridge receiving portion 58A has reached its uppermost position, the judgment of step 226 is affirmative, and the replenishing liquid replenishing processing is completed. The process returns to step 178 of the processing at the time of cartridge installation (FIG. 5). In step 178, the status code expressing “currently replenishing” is set in the status code memory area provided in the memory section 98, and the processing at the time of cartridge installation is completed.

In a case in which the seal 72, on which the two-dimensional bar code is printed, is not affixed to the replenishing liquid cartridge 56 installed in the cartridge installation section 58, or in a case in which the position at which the seal 72 is affixed is different from the predetermined position, the judgment of above step 160 is negative. In this way, in a case in which the seal 72 is not affixed or the affixed position is different, it can be determined that the replenishing liquid cartridge 56 installed in the cartridge installation section 58 is not a legitimate product.

Therefore, in step 182, by displaying on the display 110 a message such as, for example, “The installed replenishing liquid cartridge is not a legitimate product. If the replenishing liquids in this replenishing liquid cartridge are replenished, there is the possibility that problems may arise at the image forming device. Should replenishing of the replenishing liquids continue?”, the user is warned that the installed replenishing liquid cartridge 56 is not a legitimate product and that there is the possibility that problems may arise. It can then be confirmed with the user whether or not replenishing of the replenishing liquids is to be continued.

In subsequent step 184, it is judged whether or not the user has expressed the intent to continue with replenishing, on the basis of whether or not information, which means that replenishing of the replenishing liquids from the replenishing liquid cartridge 56 which is not a legitimate product is to be continued, has been inputted by the user via the input section 112. If the user has inputted, via the input section 112 information meaning that replenishing is to be stopped, the judgment in step 184 is negative, and the routine moves on to step 178 where, without carrying out the above-described replenishing liquid replenishing processing, the status code is set to “currently not replenishing”, and the processing at the time of installing the cartridge is completed. In this way, it is possible to avoid problems which may arise at the image forming device 10 due to the replenishing of replenishing liquids filled in the replenishing liquid cartridge 56 which is not a legitimate product.

On the other hand, in a case in which the user inputs, via the input section 112, information meaning that replenishing is to be continued, the judgment of step 184 is affirmative, and the routine moves on to step 186. In step 186, information expressing that the user has expressed the intent to continue with the replenishing is stored in the memory section 98 together with information expressing the date and time at that time or the like. Thereafter, the replenishing liquid replenishing processing (step 176) is carried out. In this case, due to the replenishing liquids which are filled in the replenishing liquid cartridge 56 which is not a legitimate product being replenished, there is the possibility that some type of problem may arise at the image forming device 10. However, because the fact that the user expressed an intent to continue with replenishing is stored as information, if some type of problem does arise, the cause can be easily determined, and the party responsible for the problem having occurred can be clearly known.

Note that, among the above-described processings, the processing of warning the user in step 182 specifically corresponds to the control section of the sixth aspect. The processing in step 182 of confirming with the user whether or not replenishing of the replenishing liquids is to be continued and steps 184, 186 specifically correspond to the control section of the seventh aspect.

Further, in a case in which the judgment in step 166 is affirmative due to the cartridge ID of the replenishing liquid cartridge 56 installed in the cartridge installation section 58 being stored in the memory section 98 and already registered in the cartridge ID table, in step 180, it is judged whether or not the flag is “1”.

As described above, the flag is “1” when the status code at the time of starting-up of the processing at the time of cartridge installation is “currently replenishing”. However, at the time of completion of the processing at the time of cartridge installation, the status code is set to “currently not replenishing” (step 178). Therefore, in a case in which the flag is “1” in step 180, it can be judged that there is a strong possibility that an abnormality such as, for example, a power stoppage or the like occurred during the previous time that the processing at the time of cartridge installation was carried out. Therefore, when the judgment of step 180 is affirmative, the routine moves on to step 174 where the managing center 104 is requested to register the cartridge ID in the cartridge ID master table, and thereafter, the replenishing liquid replenishing processing (step 176) is carried out.

On the other hand, if the judgment in step 180 is negative, an abnormality such as a power stoppage or the like while the processing at the time of cartridge installation was being carried out has not occurred, and it can be judged that the replenishing liquid cartridge 56 installed in the cartridge installation section 58 is not a legitimate product. (Namely, it can be judged that there is a strong possibility that the installed replenishing liquid cartridge 56 is, for example, a cartridge in which replenishing liquids have been refilled into the empty bottles of the replenishing liquid cartridge 56 which is a legitimate product and was used at the image forming device 10 in the past, or is a cartridge to which is affixed the seal 72 which was peeled off from the replenishing liquid cartridge 56 which is a legitimate product and was used at the image forming device 10 in the past.) Therefore, the routine moves on to step 182, and the above-described processings of steps 182 on are carried out. (Namely, the user is warned that the installed replenishing liquid cartridge 56 is not a legitimate product and that there is the possibility that a problem may arise, and it is confirmed with the user whether or not replenishing of the replenishing liquids is to be continued, and the processing diverges in accordance with the instruction from the user.)

Further, also in a case in which the cartridge ID of the replenishing liquid cartridge 56 installed in the cartridge installation section 58 is registered in the cartridge ID master table of the managing center 104, it can be judged that the installed replenishing liquid cartridge 56 is not a legitimate product. (Namely, it can be judged that there is a strong possibility that the installed replenishing liquid cartridge 56 is, for example, a cartridge in which replenishing liquids have been refilled into the empty bottles of the replenishing liquid cartridge 56 which is a legitimate product and was used at another image forming device 10 in the past, or is a cartridge to which is affixed the seal 72 which was peeled off from the replenishing liquid cartridge 56 which is a legitimate product and was used at another image forming device 10 in the past.) Therefore, also when the judgment of step 170 is affirmative, the routine moves on to step 182 and the above-described processings of steps 182 on are carried out.

In this way, in the processing at the time of cartridge installation relating to the present embodiment, it is judged whether or not the cartridge ID of the replenishing liquid cartridge 56 installed in the cartridge installation section 58 is registered in the cartridge ID table stored in the memory section 98. If the cartridge ID is not registered in the cartridge ID table, it is judged whether or not the cartridge ID is registered in the cartridge ID master table of the managing center 104. If the cartridge ID is also not registered in the cartridge ID master table, it is judged that the installed replenishing liquid cartridge 56 is a legitimate product. Therefore, also in cases in which a replenishing liquid cartridge which is not a legitimate product is installed, that fact can be reliably notified to the user.

Note that the above describes, as an example, a case in which the managing center 104 carries out only processing relating to the cartridge ID master table (i.e., confirming whether or not the cartridge ID, for which there was an inquiry from the image forming device 10, is registered in the cartridge ID master table, and registering a cartridge ID, for which there is a request to register, in the cartridge ID master table). However, the present invention is not limited to the same. For example, the managing center 104 may collect, via the communication network 102, and store, in the storage device 106 or the like, information expressing the work histories and the error histories from the image forming devices 10, and in a case in which there is some type of problem at a specific image forming device 10, the managing center 104 may carry out processing for providing information relating to that specific image forming device 10 in order to find the cause of the problem.

In this mode, the information which the managing center 104 collects and stores is not limited to information expressing the work histories or the error histories from the image forming devices 10. For example, the manufacturer of the replenishing liquid cartridge 56 may, at the time of shipping the replenishing liquid cartridge 56 out, make the replenishing liquid cartridge 56 also bear information expressing the shipping date (e.g., affixing the seal 72 on which is printed a two-dimensional bar code which expresses predetermined information to which shipping date information is also added, or the like). In the processing at the time of cartridge installation, when the image forming device 10 requests the managing center 104 to register in the cartridge ID master table the cartridge ID read from the replenishing liquid cartridge 56, the shipping date information read from the replenishing liquid cartridge 56 also may be transmitted. On the basis of the shipping date expressed by the shipping date information which is received together with the present date, the managing center 104 may compute the number of days that the installed replenishing liquid cartridge 56 was stored (the number of days from the shipping of the replenishing liquid cartridge 56 to the installation thereof in the image forming device 10), and may store the computed number of days of storage as well in the storage device 106 or the like. The number of days of storage can be used, for example, in estimating the product quality or the like of the replenishing liquids filled in the installed replenishing liquid cartridge 56.

Further, the above described, as an example, a case in which, when the cartridge ID of the replenishing liquid cartridge 56 installed in the cartridge installation section 58 is not registered in the cartridge ID table of the image forming device 10, it is further confirmed whether or not the cartridge ID is registered in the cartridge ID master table of the managing center 104. However, the present invention is not limited to the same. It can be judged whether or not the replenishing liquid cartridge is a legitimate product, on the basis of only whether or not the cartridge ID is not registered in the cartridge ID table of the image forming device 10. In such a mode, the accuracy of judging whether or not the replenishing liquid cartridge is a legitimate product slightly deteriorates, but there is no need for the image forming device 10 to carry out communication with the managing center 104. Therefore, the cost of the image forming device 10 itself, and the running cost thereof, can be decreased.

Moreover, the above describes, as an example, a case in which the predetermined information, which includes the cartridge ID and other information, is borne by affixing the seal 72, on which the two-dimensional bar code is printed, to the replenishing liquid cartridge 56 which serves as the replaceable product relating to the present invention. However, the present invention is not limited to the same. The replaceable product can be made to bear identification information and the like by attaching, to the replaceable product, a recording element (e.g., an RFID tag or the like corresponding to the recording element of the third aspect) at least from which information can be read in a wireless manner and on which is written in advance the identification information and the like relating to the present invention or the like. Further, the replaceable product relating to the present invention is not limited to the replenishing liquid cartridge.

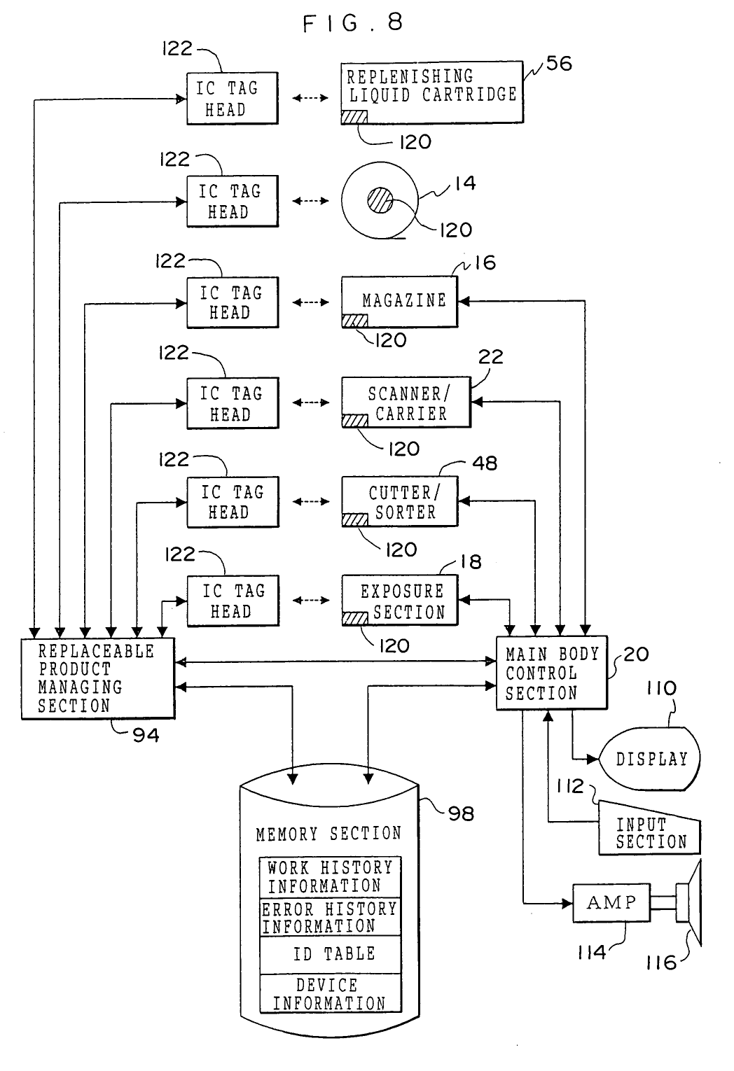

For example, at the image forming device 10, in addition to the replenishing liquid cartridge 56 being freely installable and removable, the photographic printing paper roll 14 and the magazine 16 also are freely installable and removable. The cutter/sorter 48 can be selectively installed from among plural types of cutter/sorter units which are readied in advance. The exposure section 18 can be replaced as a part. The scanner/carrier 22 can be connected to and disconnected from the image forming device 10. (Hereinafter, such parts are collectively called replaceable products.) Therefore, as shown in FIG. 8 as an example, an RFID tag 120, on which ID (identification information) for identifying the replaceable product is written in advance, may be attached to each of the replaceable products (e.g., the RFID tag 120 can be attached to the core of the photographic printing paper roll 14), and IC tag heads 122 may be set at positions of the image forming device 10 at which wireless communication with the RFID tags 120 attached to the respective replaceable products is possible.

In FIG. 8, the respective IC tag heads 122 are connected to the replaceable product managing section 94. For each of the replaceable products, a table for registration of the IDs of the replaceable products which were installed in the past (illustrated as “ID table” in FIG. 8) is provided, in the same way as with the cartridge ID table. When a replaceable product is replaced, the ID of the replaceable product to be newly installed is read out from the RFID tag 120. By searching the corresponding table by using the read ID as a key, it is possible to judge whether or not the replaceable product to be newly installed is a legitimate product.

Moreover, among RFID tags, there is a type at which wireless writing of information also can be carried out. The RFID tag 120 attached to at least one of the replaceable products (e.g., the replenishing liquid cartridge 56) may be this type at which writing of information also is possible. At the image forming device 10, work history information expressing the work history of the image forming device 10 and error history information expressing the history of errors which have arisen, may be cumulatively stored in the memory section 98. At the time of replacing the replaceable product to which the information-writable RFID tag is attached, the work history information and the error history information may be written to the RFID tag of that replaceable product. In this way, by recovering the used replaceable products and the managing center or the like reading the information written in the RFID tags, the work histories and error histories and the like of the image forming devices 10 can be collected and managed. This can be useful in determining the cause of a problem when some type of problem arises at the image forming device 10, even in an environment in which the image forming device 10 and the managing center or the like are not connected via a communication network.

Note that, in FIG. 8, the IC heads 122 are respectively disposed in correspondence with the RFID tags 120 attached to the respective replaceable products, in consideration of the fact that the wireless communication between the RFID tags 120 and the IC tag heads 122 is carried out by a communication method (e.g., an electromagnetic coupling method or the like) in which the distance over which communication is possible is relatively short. However, if a communication method in which the distance over which communication is possible is longer (e.g., a microwave method or a light method or the like) is employed as the wireless communication between the RFID tags 120 and the IC tag heads 122, a single IC tag head 122 may be provided so as to correspond to the plural RFID tags 120.

As described above, in the present invention, when a predetermined replaceable product is installed, identification information held on the replaceable product is read. By judging whether or not the read identification information is not stored in a storing section which stores identification information which was held on replaceable products which were installed in the past, it is judged whether or not the replaceable product is a legitimate product, and that identification information is stored in the storing section. Therefore, the present invention has the excellent effect that, when a replaceable product which is not a legitimate product is installed, that fact can be known.

What is claimed is:

1. An image forming device in and from which a predetermined replaceable product can be freely installed and removed, and which carries out image forming processing by using an installed replaceable product, the image forming device comprising:
a reading section for, at a time of installing a predetermined replaceable product, reading identification information which is held on the replaceable product and which is for identifying that replaceable product from other replaceable products;
a storing section for storing identification information held on replaceable products which were installed in the past; and
a control section for judging whether or not the replaceable product is a legitimate product by judging whether or not the identification information read by the reading section is not stored in the storing section, and for storing the identification information in the storing section if the identification information is not stored in the storing section.

2. The image forming device of claim 1, wherein the identification information is recorded on the replaceable product as a two-dimensional bar code.

3. The image forming device of claim 1, wherein a recording element, at least from which written information can be read, is attached to the replaceable product, and the identification information is written in advance to the recording element.

4. The image forming device of claim 1, wherein the identification information is held in an encrypted state on the replaceable product, and the reading section reads the identification information by decrypting the information read from the replaceable product.

5. The image forming device of claim 1, wherein the image forming device is connected via a communication line to a managing device which stores identification information held on replaceable products which have been installed in the past in plural image forming devices, and if the read identification information is not stored in the storing section, the control section judges whether or not the replaceable product is a legitimate product by confirming whether or not the read identification information is not stored in the managing device.

6. The image forming device of claim 1, wherein, when the control section judges that the replaceable product is not a legitimate product, the control section one of issues a warning and carries out processing for preventing use of the replaceable product.

7. The image forming device of claim 1, wherein, when the control section judges that the replaceable product is not a legitimate product, the control section confirms with a user whether or not the replaceable product is to be used, and if the user instructs use of the replaceable product, the control section stores, in the storing section, information expressing that the user instructed use of the replaceable product.

8. The image forming device of claim 1, wherein the replaceable product is a cartridge in which is filled a replenishing liquid for replenishing a processing liquid stored in the image forming device, and replenishing condition information, which expresses conditions for replenishing the replenishing liquid filled in the cartridge to the processing liquid, is also held on the cartridge, and the control section controls replenishment of the replenishing liquid to the processing liquid on the basis of the replenishing condition information read from the cartridge by the reading section.

9. The image forming device of claim 1, wherein voice information, which expresses a voice explaining in a predetermined language work procedures for one of installing and replacing the replaceable product, also is recorded at the replaceable product, and the image forming device further comprises a playback section for playing-back, as a voice, the voice information read by the reading section.

10. An image forming device in and from which a predetermined replaceable product can be freely installed and removed, and which carries out image forming processing by using an installed replaceable product, the image forming device comprising:
a reading section for, at a time of installing a predetermined replaceable product, reading identification information which is held on the replaceable product and which is for identifying that replaceable product from other replaceable products;
a storing section for storing identification information held on replaceable products which were installed in the past; and
a control section for judging that the replaceable product is a legitimate product in a case in which the reading section cannot read the identification information, and for judging whether or not the replaceable product is a legitimate product by judging whether or not the identification information read by the reading section is not stored in the storing section, and for storing the identification information in the storing section if the identification information is not stored in the storing section.

11. The image forming device of claim 10, wherein, when the control section judges that the replaceable product is not a legitimate product, the control section one of issues a warning and carries out processing for preventing use of the replaceable product.

12. The image forming device of claim 10, wherein, when the control section judges that the replaceable product is not a legitimate product, the control section confirms with a user whether or not the replaceable product is to be used, and if the user instructs use of the replaceable product, the control section stores, in the storing section, information expressing that the user instructed use of the replaceable product.

13. An image forming device in and from which a predetermined replaceable product can be freely installed and removed, and which carries out image forming processing by using an installed replaceable product, the image forming device comprising:
a reading section for, at a time of installing a predetermined replaceable product, reading identification information which is held on the replaceable product and which is for identifying that replaceable product from other replaceable products;
a storing section for storing identification information held on replaceable products which were installed in the past; and
a control section for judging whether or not the replaceable product is a legitimate product by judging whether or not the identification information, which indicates that a type of the replaceable product is the same as that of the predetermined replaceable product and identifies that replaceable product from other replaceable products, read by the reading section is not stored in the storing section, and for storing the identification information in the storing section if the identification information is not stored in the storing section.
